(19) United States
(12) Patent Application Publication
(10) Pub. No.: US 2025/0353091 A1
(43) Pub. Date: Nov. 20, 2025

(54) ANTENNA DEVICE AND METHOD FOR MANUFACTURING THE SAME

(71) Applicant: SUMIDA CORPORATION, Tokyo (JP)

(72) Inventors: Ryuhei HATA, Natori City (JP); Nobuyuki TAKAHASHI, Natori City (JP); Daichi GEMBA, Natori City (JP); Junji MORITA, Natori City (JP); Tomoya TANITA, Natori City (JP); Kai Maeno, Natori City (JP)

(21) Appl. No.: 19/108,350

(22) PCT Filed: Sep. 29, 2022
(86) PCT No.: PCT/JP2022/036453

§ 371 Date: Mar. 3, 2025

(51) Int. Cl. B23K 1/005; B23K 1/00; B23K 101/36; H01Q 7/00

(52) U.S. Cl. CPC B23K 1/0056; B23K 1/0016; H01Q 7/00; B23K 2101/36

(57) ABSTRACT

A method for manufacturing an antenna device comprises melting a brazing material and a removing a part of an insulating film. The antenna device includes an antenna portion formed by winding a coil wire having a coil core covered with the insulating film, and a base having a pad portion to which a part of the coil wire is brazed with the brazing material. In melting the brazing material, the brazing material supplied onto the pad portion is irradiated with a laser beam so that the brazing material melts. In removing a part of the insulating film, the coil wire is immersed in the molten brazing material so that a part of the insulating film is removed from the coil wire, and the coil wire and the pad portion are joined with the brazing material.

### CROSS REFERENCE TO RELATED APPLICATIONS

This application is a 371 U.S. National Phase of International Application No. PCT/JP2022/036453, filed on Sep. 29, 2022. The entire disclosure of the above application is incorporated herein by reference.

### BACKGROUND

### Technical Field

The present invention relates to an antenna device and a method for manufacturing the same.

### Related Art

Among antenna devices is an antenna device that includes an antenna formed by winding a coil wire, and a circuit portion to which the coil wire is electrically connected by soldering, for example.

Regarding such type of technology, Japanese Translation of PCT International Application Publication No. 2014-505309 (Patent Document 1) discloses a method for manufacturing an RFID transponder which includes an antenna (4) made from a winding wire (2) and in which the winding wire (2) is soldered to a solderable contact area (12). Specifically, as shown in FIG. 1 of Patent Document 1, the solderable contact area (12) is provided on the upper face of a semiconductor die (6). The contact area (12) is a metal plating made from a nickel based alloy, for example. An end portion of the winding wire (2) is soldered to the contact area (12). Specifically, an area to be soldered is irradiated with a laser beam so that the solder is melted by the laser beam, and the winding wire (2) and the contact area (12) are thus joined.

Typically, a coil wire wound on an antenna is covered with an insulating film. To solder the winding wire (2) to the contact area (12) as in Patent Document 1, the insulating film on at least a portion of the winding wire (2) to be soldered needs to be removed in advance. According to Patent Document 1, a step of removing the insulating film is performed before the soldering process, using the same laser device as a laser device used to soler the winding wire (2) to the contact area (12). That is, the step of removing the insulating film needs to be performed before the soldering step. This results in increased manufacturing steps for the manufacture of an antenna device, which is problematic.

Such a problem occurs in all types of brazing performed with not only solder but also other metal brazing materials.

The present invention has been made in view of the foregoing problem, and provides an antenna device and a method for manufacturing the same that involve a small number of manufacturing steps.

### SUMMARY

A method for manufacturing an antenna device of the present invention is a method for manufacturing an antenna device, the antenna device including an antenna portion formed by winding a coil wire having a coil core covered with an insulating film, and a base having a pad portion to which a part of the coil wire is brazed with a brazing material, the method comprising melting the brazing material by irradiating the brazing material supplied onto the pad portion with a laser beam; and removing a part of the insulating film from the coil wire by immersing the coil wire in the molten brazing material, thereby joining the coil wire and the pad portion with the brazing material.

An antenna device of the present invention is an antenna device including an antenna portion formed by winding a coil wire having a coil core and an insulating film covering the coil core; and a base including a pad portion, in which the coil wire includes an exposed portion of the coil core that is uncovered with the insulating film and thus is exposed, the coil wire and the pad portion are joined with a brazing material, a part of the coil wire is buried in the brazing material, and a first boundary line and a second boundary line are arranged along each other, the first boundary line being a boundary between, regarding a peripheral face of the coil wire, an interior region buried in the brazing material and an exterior region located outside of the brazing material, the second boundary line being a boundary between the exposed portion and a covered portion of the coil wire that is covered with the insulating film.

### Effect of the Invention

According to the manufacturing method of the present invention, an insulating film immersed in a molten brazing material is removed from a coil wire with the heat of the molten brazing material. Accordingly, it is possible to perform a brazing step and a step of removing the insulating film from the coil wire at the same time, and thus reduce the manufacturing steps for the antenna device.

### BRIEF DESCRIPTION OF THE DRAWINGS

The foregoing object as well as other objects, features, and advantages will become further clearer from the following preferred embodiment and the accompanying drawings.

FIG. 1 is a perspective view showing an example of an antenna device according to a first embodiment of the present invention.

FIG. 2 is a top view of a circuit portion of the antenna device according to the first embodiment.

FIG. 3 is a longitudinal sectional view of a cross-section of the antenna device according to the first embodiment along a dashed and single-dotted line shown in FIG. 2 as seen in the direction of arrows III-III.

FIG. 4 is an enlarged view of a portion indicated by X in FIG. 2 of the antenna device according to the first embodiment.

FIG. 5 is a longitudinal sectional view of a cross-section of the antenna device according to the first embodiment along a dashed and single-dotted line shown in FIG. 4 as seen in the direction of arrows V-V.

FIG. 6 is a perspective view of an antenna device for showing an example of a method for manufacturing the antenna device according to the first embodiment.

FIG. 7 is a top view of the antenna device for showing an example of the method for manufacturing the antenna device according to the first embodiment.

FIG. 8 is a longitudinal sectional view of a cross-section of the antenna device according to the first embodiment along a dashed and single-dotted line shown in FIG. 7 as seen in the direction of arrows VIII-VIII.

FIG. 9 is a longitudinal sectional view of a cross-section of the antenna device according to the first embodiment along a dashed and single-dotted line shown in FIG. 7 as seen in the direction of arrows IX-IX.

FIG. 10 is a perspective view showing an example of a pressure jig used in the method for manufacturing the antenna device according to the first embodiment.

FIG. 11 is a perspective view showing an example of the placement of the pressure jig in the method for manufacturing the antenna device according to the first embodiment.

### DETAILED DESCRIPTION

Various components of the antenna device of the present invention need not be independent. For example, a configuration in which a plurality of components are formed as a single unitary member, a configuration in which a single component is formed of a plurality of members, a configuration in which a given component is a part of another component, and a configuration in which a part of a given component partially overlaps a part of another components, are all acceptable.

In addition, although the method for manufacturing the antenna device of the present invention may be described based on a plurality of steps in the order in which they appear, such order shall not limit the order or timings for executing the plurality of steps. Therefore, when the method for manufacturing the antenna device of the present invention is performed, the order of the plurality of steps may be changed unless a problem would arise to carry out the present invention. Further, the timings for executing the plurality of steps may partially or entirely overlap.

Hereinafter, an embodiment of the present invention will be described based on the drawings. Throughout the drawings, corresponding components are denoted by common reference signs, and the description of such components will not be repeated.

The present embodiment will be described with directions including the front, rear, left, right, up, and down defined as shown in the drawings. In addition, an end portion on the front side and an end portion on the rear side of a base 30, an antenna portion 20, or a coil wire 40 may be respectively referred to as a front end and a rear end. Further, the left-right direction may be referred to as a width direction, and the up-down direction may be referred to as a height direction. A direction from the center line of the base to the left or right in the left-right direction shall be referred to as an outer side or outward, while a direction from the left or right to the center line of the base shall be referred to as an inner side or inward. Further, a direction orthogonal to the up-down direction, that is, the left-right direction and the front-rear direction may be collectively referred to as a lateral direction. However, all of such directions are just defined for convenience sake to simplify the description of the relative relationships among the components, and shall not define the directions when a product for implementing the present invention is manufactured or used.

Further, a plane as referred to in the present invention means a shape that is physically formed to obtain a plane as a target, and obviously does not require a complete geometric plane.

### First Embodiment

### (Overview of Antenna Device)

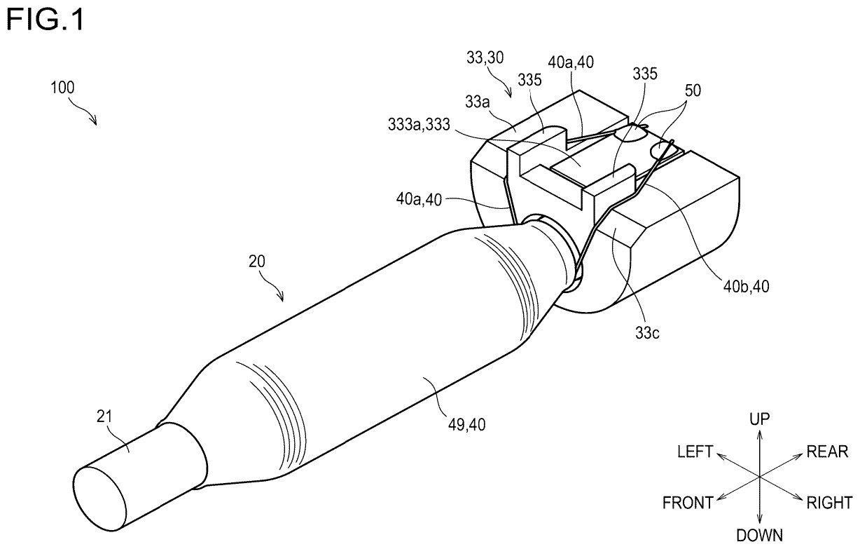

FIG. 1 is a perspective view showing an example of an antenna device 100 according to a first embodiment of the present invention.

First, an overview of the antenna device 100 of the present embodiment will be described.

The antenna device 100 includes an antenna portion 20, and a base (a circuit portion 33) having a pad portion 331. The antenna portion 20 has wound thereon a coil wire 40 that includes a coil core 47 and an insulating film 46 covering the coil core 47. The coil wire 40 and the pad portion 331 are joined with a brazing material 50.

Next, the details of the antenna device 100 of the present embodiment will be described with reference to FIGS. 1 to 5.

The antenna device 100 can be used for a compact, portable communication system, such as a receiving/transmitting device used for a keyless entry system, for example, or can be used as an RFID transponder used to identify goods, such as commercial products. For example, the antenna portion 20 functions as an antenna that transmits and receives radio waves in the antenna device 100. In the present embodiment, the antenna portion 20 includes a winding core 21, and the coil wire 40 is wound on the winding core 21. As shown in FIG. 1, the opposite ends of the coil wire 40 are arranged on the base 30 side (the rear end side) of the winding core 21. In addition, the coil wire 40 (a coil portion 49) is wound on the middle portion of the winding core 21 in the axial direction. That is, the coil wire 40 is not wound on a part of the front end of the winding core 21.

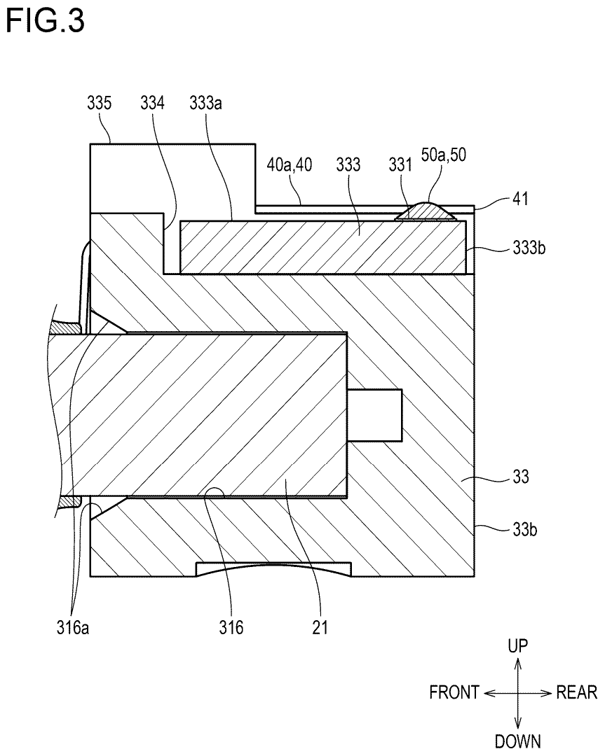

Regarding the coil portion 49 shown in FIG. 1, each turn of the coil wire 40 wound on the winding core 21 is not shown in the drawings. The same holds true for FIGS. 3, 6, 7, 9, and 11.

The shape of the antenna portion 20 is not limited to the one of the present embodiment, and various shapes that allow the antenna portion 20 to function as an antenna may be employed. For example, it is possible to use an air-core coil in which the coil portion 49 has a hollow inside without the winding core 21. It is also possible to wind the coil wire 40 by arranging it in an annular shape on a plane. The opposite ends of the coil wire 40 are drawn toward the base 30.

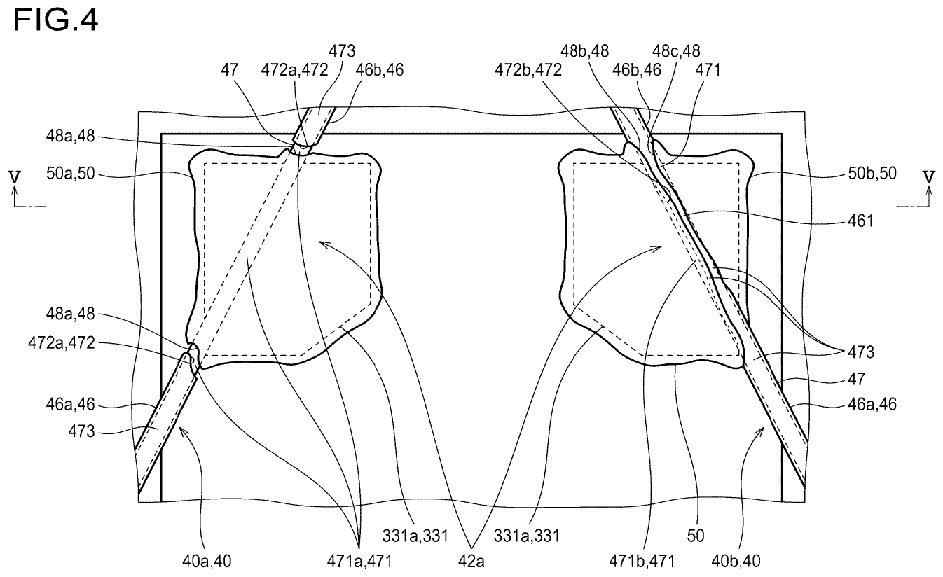

The coil wire 40 is a conductive wire rod. The coil wire 40 of the present embodiment includes the coil core 47 (see FIG. 4), which is formed of a conductive metal such as copper, covered with the insulating film 46 (see FIG. 4). Examples of the material of the insulating film 46 include resin, such as polyurethane and polyimide.

In the present embodiment, the winding core 21 is inserted into a winding core insertion hole 316 (see FIG. 3) provided on the front end side of the base 30 described below, and thus is fixed to the base 30. As shown in FIG. 3, an opening of the winding core insertion hole 316 is provided with a chamfered portion 316a to allow for the smooth insertion of the winding core 21 into the winding core insertion hole 316. An end face (a face opposite the rear end side) of the winding core 21 is in contact with the bottom face (a face opposite the rear end side) of the winding core insertion hole 316.

The base 30 (the circuit portion 33) is a member for disposing thereon a circuit body 333 to which coil wires 40a and 40b drawn from the coil portion 49 are connected. The base 30 may include, in addition to the circuit portion 33, a wire arrangement portion 31 used in the method for manufacturing the antenna device 100 described below. Hereinafter, the circuit portion 33 may also be referred to as the base 30, or the circuit portion 33 and the wire arrangement portion 31 may also be collectively referred to as the base 30.

In the present embodiment, the circuit portion 33 has the shape of a semicylinder with a substantially semicircular bottom face as shown in FIG. 1. The circuit portion 33 is arranged such that a semicircular face, which corresponds to the bottom face of the semicylinder, faces the front-rear direction, a planar portion (an upper face 33a) of the side face of the semicylinder faces upward, and a curved peripheral face of the side face of the semicylinder faces downward. The shape of the circuit portion 33 is not limited to such a semicylinder having a semicircular bottom face, and may be other shapes, such as a flat plate, a prism, and a cylinder.

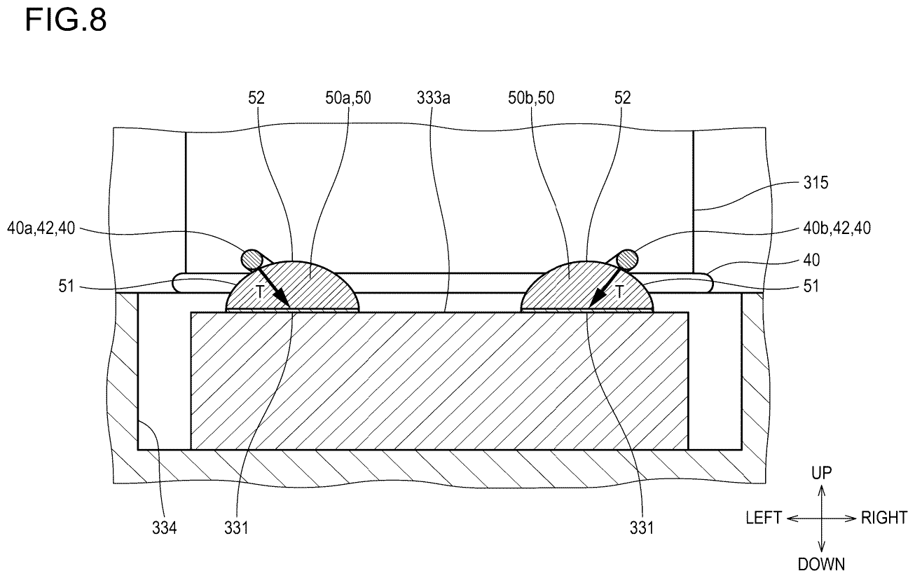

In the present embodiment, the upper face 33a of the circuit portion 33 is provided with a placement hole 334 that is recessed downward (see FIGS. 3 and 8). In the present embodiment, as shown in FIG. 3, the placement hole 334 is open on its upper side and on its rear end side. The placement hole 334 may also be shaped such that it is open only on its upper side.

The bottom face of the placement hole 334 has sufficient dimensions and shape to dispose the circuit body 333 described below thereon. Specifically, in the present embodiment, to house the circuit body 333 that is rectangular with its long side lying in the front-rear direction, the placement hole 334 is also shaped rectangular with its long side lying in the front-rear direction. The lengths of the placement hole 334 in the width direction and in the front-rear direction are respectively equal to or greater than the lengths of the circuit body 333 in the width direction and in the front-rear direction.

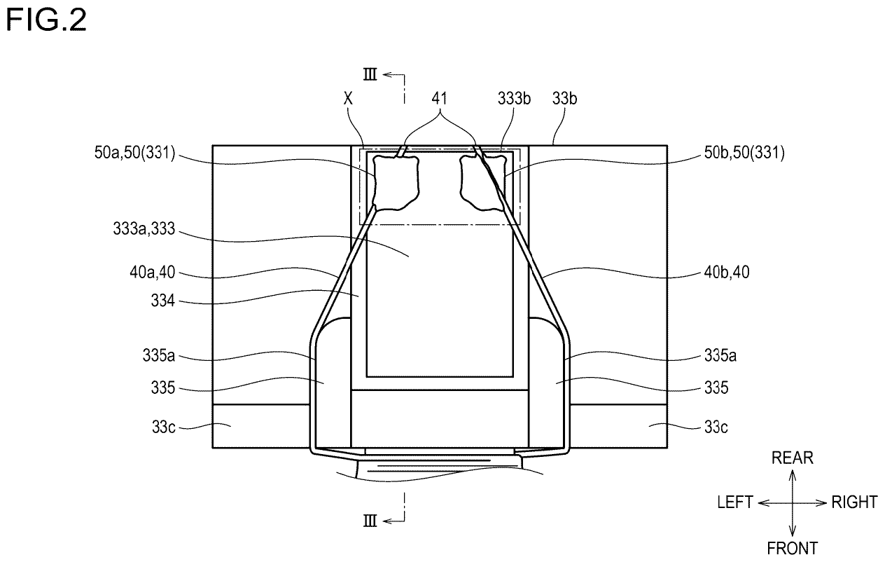

In the present embodiment, the lengths of the placement hole 334 in the width direction and in the front-rear direction are respectively greater than the lengths of the circuit body 333 in the width direction and in the front-rear direction. As shown in FIG. 2, there is a gap between the circuit portion 33 and the circuit body 333 on each of the front end side, the left side, and the right side of the circuit body 333.

The circuit body 333 is housed within the placement hole 334. The phrase “be housed within” means that the circuit body 333 is partially or entirely disposed within the placement hole 334. In the present embodiment, an upper face 333a of the circuit body 333 is lower than the upper face 33a of the circuit portion 33 as described below. That is, as shown in FIG. 3, the circuit body 333 is entirely housed within the placement hole 334, but the present invention is not limited thereto. The upper portion of the circuit body 333 may be located higher than the upper face 33a of the circuit portion 33. It is also possible to provide a configuration in which the circuit portion 33 has no placement hole 334, and the circuit body 333 is disposed on the upper face 33a of the circuit portion 33.

The circuit body 333 is a member that has the pad portion 331 (see FIGS. 2 and 3) described below and is connected to the coil wire 40, and is also a circuit board for mounting thereon semiconductor parts and the like. The circuit board may be coated with resin or the like, and may be housed within a cavity member, for example. In the present embodiment, the circuit body 333 and the circuit portion 33 for disposing the circuit body 333 thereon are separate members, but the present invention is not limited thereto. The circuit body 333 and the circuit portion 33 may be formed as a single unitary member.

The upper face 333a of the circuit body 333 has the pad portion 331 disposed thereon. The pad portion 331 is a member supplied with the brazing material 50 for brazing the coil wire 40 to the pad portion 331. Specifically, the pad portion 331 is a portion plated with a conductive metal, such as copper or nickel, in a thin film form. The pad portion 331 connects to a part forming a circuit of a semiconductor substrate, for example. Thus, the coil wire 40 and the part forming the circuit are electrically connected via the pad portion 331.

The thickness (the length in the height direction) of the pad portion 331 is preferably smaller than a base height h2 (the height of the upper face 33a of the circuit portion 33 with reference to the upper face 333a of the circuit body 333) described below.

As shown in FIGS. 2 and 4, in the present embodiment, two pad portions 331 are respectively provided at two positions on the upper face 333a of the circuit body 333. This is to join the opposite ends of the coil wire 40 to the respective pad portions 331. More specifically, the respective pad portions 331 of the present embodiment are arranged in the left side region and the right side region on the rear end side of the upper face 333a of the circuit body 333. The left and right pad portions 331 are arranged at line-symmetric positions with respect to the center line of the circuit body 333 in the left-right direction, and thus have a line-symmetric shape.

In the present embodiment, the opposite ends of the coil wire 40 are respectively joined to the pair of pad portions 331 provided on the base 30 via the brazing material 50. Each of the pair of pad portions 331 is formed in a substantially rectangular shape with its long side lying in the front-rear direction. In addition, each rectangular shape has a shape with an oblique side 331a (see FIG. 4) formed by chamfering a corner on the inner side of each of the pair of pad portions 331. Specifically, each rectangle is shaped such that a corner located on the inner side and the front end side of the rectangle is chamfered. That is, the pad portion 331 has a pentagonal shape. In addition, the oblique side 331a lies along the extension direction of the coil wire 40. Herein, the extension direction of the coil wire 40 is the axial direction of the coil wire 40. The phrase “the extension direction of the coil wire 40 and the oblique side 331a lie along each other” means that the extension direction of the coil wire 40 and the oblique side 331a are preferably substantially parallel, and means that an acute angle of the angles made by the extension direction of the coil wire 40 and the oblique side 331a is at least 45 degrees or less.

The coil wire 40 drawn from the antenna portion 20 is arranged on the base 30, and is joined to each pad portion 331.

As shown in FIG. 1, a corner at the boundary between a side face on the front end side of the base 30 and the upper face 33a is chamfered so that an inclined face 33c is provided. In addition, the front end side of the base 30 is provided with a pair of guide members 335 protruding beyond the upper face 33a of the circuit portion 33 and spaced apart in the left-right direction. As shown in FIG. 2, the guide members 335 are respectively arranged on the outer side of the pair of pad portions 331. Each guide member 335 has a substantially rectangular shape with its long side lying in the front-rear direction, and has a rounded corner at the boundary between a side face on the rear end side and a side face on the outer side. That is, a part of an outer side face 335a (see FIG. 2) located on the outer side of each guide member 335 is a curved peripheral face.

As shown in FIGS. 1 and 2, the coil wire 40 drawn toward the base 30 is arranged along the inclined face 33c and the outer side face 335a of each guide member 335. Further, the coil wire 40 is arranged along the upper face 33a of the circuit portion 33 and the outer side face 335a of each guide member 335. That is, the coil wire 40 bends along the curved peripheral face forming a part of the outer side face 335a. One end portion of the coil wire 40 is brazed to the pad portion 331 arranged on the inner side of the guide member 335. In addition, as shown in FIGS. 2 and 4, in the present embodiment, one end of the coil wire 40 partially protrudes to the rear end side beyond the brazing material 50.

Examples of the brazing material 50 for brazing the coil wire 40 to the pad portion 331 include metal brazing materials, such as solder and gold solder. The brazing material 50 melts in a melting step described below, and the resulting molten brazing material 50 comes into contact with the coil core 47 of the coil wire 40 as well as the pad portion 331, thereby forming an alloy layer between the coil core 47 and the pad portion 331.

The following description is based on the assumption that the brazing material 50 is solder 50.

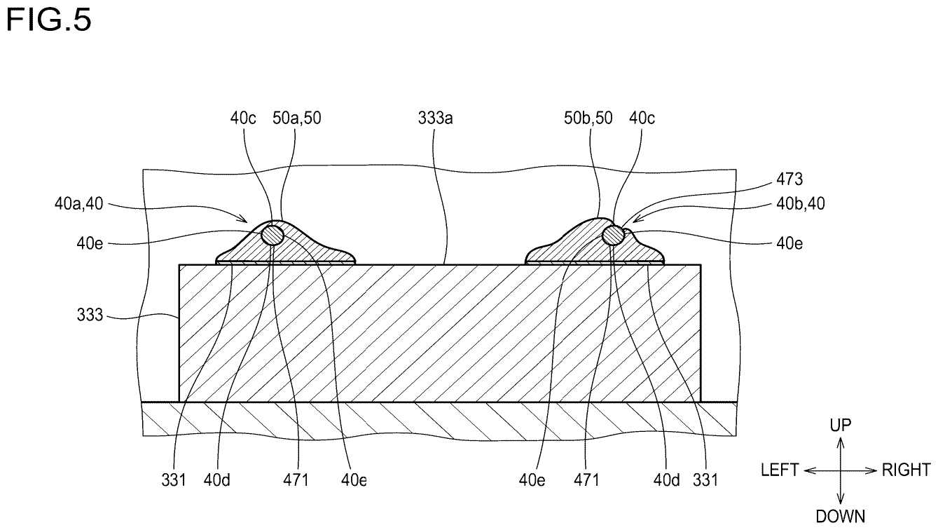

The coil wire 40 is partially buried in the brazing material 50 (the solder 50). Herein, the phrase “the coil wire 40 is partially buried in the brazing material 50” is not limited to a configuration in which, like solder 50a shown in FIGS. 4 and 5, the solder 50 entirely covers the coil wire 40 in the radial direction, and the coil wire 40 is entirely surrounded by the solder 50 in a partial length region of the coil wire 40. For example, it is possible to provide a configuration in which, like solder 50b shown in FIGS. 4 and 5, there is no portion where the coil wire 40 is entirely covered in the radial direction with the solder 50, but instead, a part of the coil wire 40 in the radial direction is covered with the solder 50, while another part of the coil wire 40 in the radial direction is uncovered with the solder 50. That is, only a part of the radial direction may be an exterior region described below, while another part of the radial direction may be an interior region described below. Preferably, regarding a given point of the coil wire 40, equal to or more than a half of the perimeter of the coil wire 40 or further preferably, equal to or more than ¾of the perimeter of the coil wire 40 is covered with the solder 50. The “radial direction” herein is a direction that starts from the axial center of the coil wire 40 and is orthogonal to the axial center, that is, a direction extending radially from the axial center of the coil wire 40 to the peripheral face thereof.

### (Method for Manufacturing Antenna Device)

Next, a method for manufacturing the antenna device 100 of the present embodiment (hereinafter also referred to as the present method) will be described.

First, an overview of the present method will be described.

The antenna device 100 manufactured with the present method includes, as described above, the antenna portion 20 formed by winding the coil wire 40 having the coil core 47 covered with the insulating film 46, and the base 30 having the pad portions 331 to which a part of the coil wire 40 is brazed with the brazing material 50.

The present method includes a melting step and a removal step. In the melting step, the brazing material 50 supplied onto each pad portion 331 is irradiated with a laser beam so that the brazing material 50 melts. In the removal step, the coil wire 40 is immersed in the molten brazing material 50 so that a part of the insulating film 46 is removed from the coil wire 40. Thus, the coil wire 40 and the pad portion 331 are joined with the brazing material 50. The present method of the present embodiment also includes a wire arrangement step performed before the melting step and the removal step as described below, and a cutting step performed after the melting step and the removal step.

Hereinafter, the base 30 in the present method will be described first.

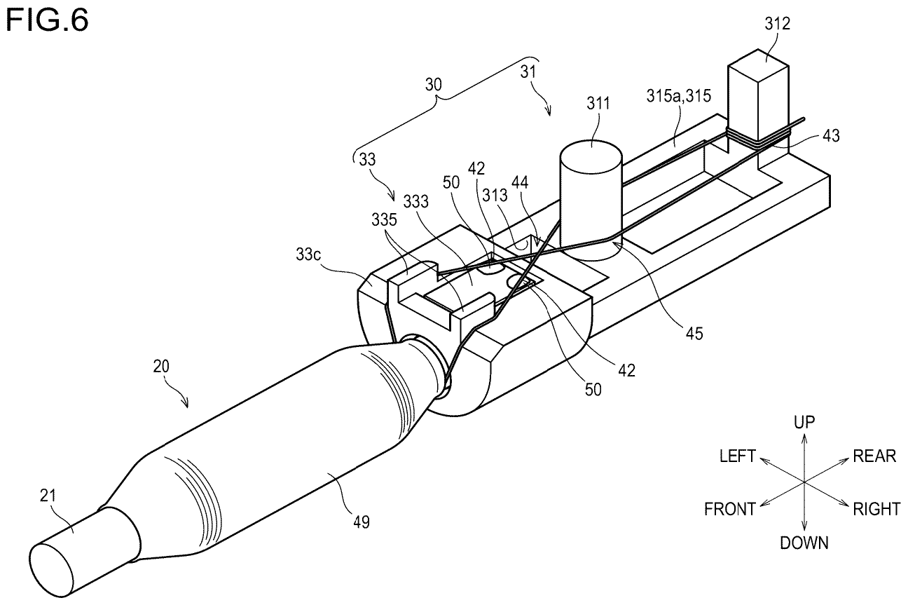

In the present method, the base 30 includes the circuit portion 33 and the wire arrangement portion 31 as shown in FIG. 6. The wire arrangement portion 31 is a portion for fixing an end portion of the coil wire 40 in place in the base 30. In the present embodiment, the wire arrangement portion 31 is a plate-like member that is long in the front-rear direction. That is, the wire arrangement portion 31 extends in the front-rear direction. The main face of a plate-like portion (a flat plate portion 315) of the wire arrangement portion 31 faces the up-down direction. The shape of the wire arrangement portion 31 is not limited to a flat plate, and may be other shapes, such as a semicylinder.

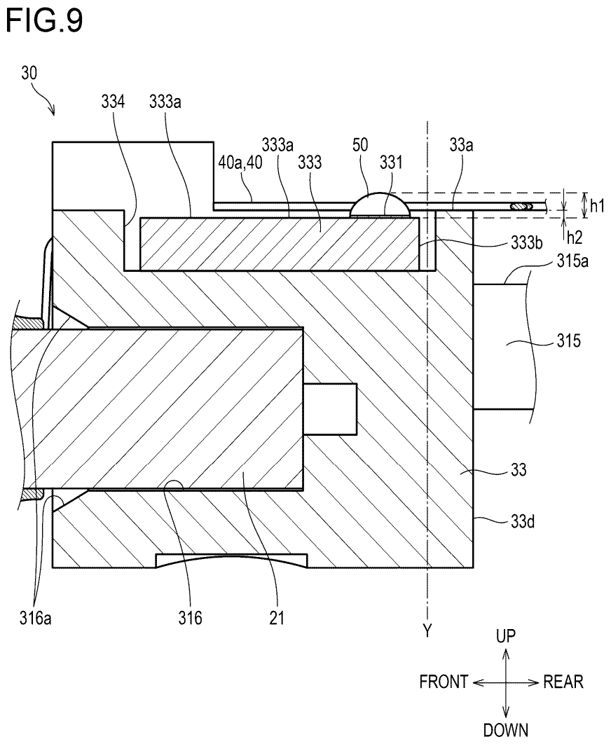

The wire arrangement portion 31 is arranged on a side of the circuit portion 33 opposite to the antenna portion 20, that is, on the rear end side of the circuit portion 33. In the present embodiment, the wire arrangement portion 31 is formed integrally with the circuit portion 33. In addition, as shown in FIG. 9, an upper face 315a of the flat plate portion 315 is located at a level lower than the upper face 33a of the circuit portion 33.

The base 30 (the wire arrangement portion 31) includes a wire fixation portion 312 for fixing the coil wire 40 thereto. The wire fixation portion 312 is a portion to which an end portion of the coil wire 40 is fixed. In the present embodiment, the wire fixation portion 312 is a quadrangular prism protruding upward from the upper face 315a of the flat plate portion 315 on the rear end side. As described below, tying up the coil wire 40 to the protruding quadrangular prism can fix the coil wire 40 thereto. The shape of the wire fixation portion 312 is not limited to an upwardly protruding shape, and it is acceptable as long as the wire fixation portion 312 has a shape or function for fixing one end of the coil wire 40 thereto, such as a portion protruding in the left-right direction, toward the rear end, or in the downward direction, or a hook shape.

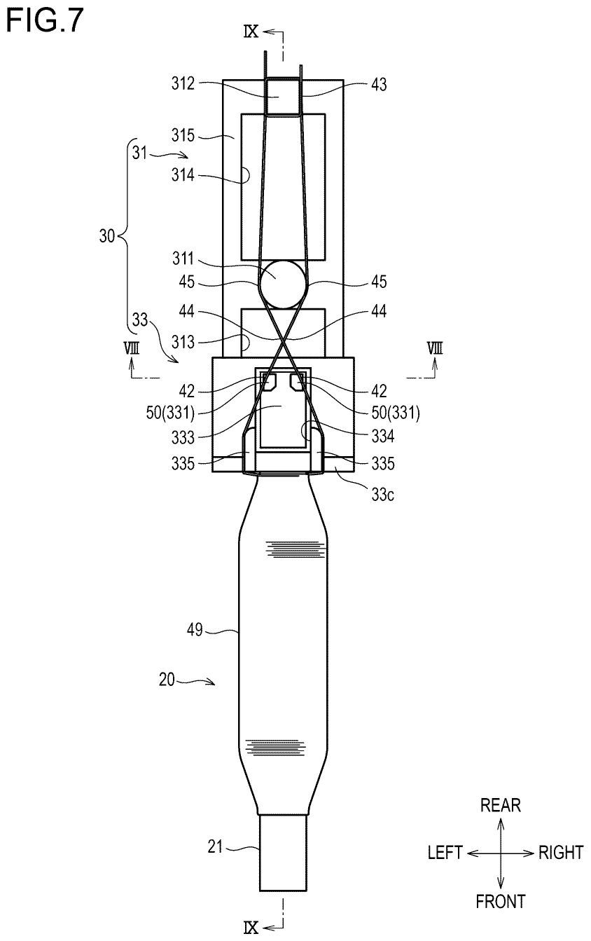

In addition, a cut-out hole 314 (see FIG. 7) with a rectangular shape with its long side lying in the front-rear direction is provided between a support portion 311 and the wire fixation portion 312 of the flat plate portion 315.

Next, the present method will be described in detail in order with reference to FIGS. 6 to 11.

In the present embodiment, the solder 50 is supplied onto the surface of each pad portion 331 in advance before the wire arrangement step described below. Specifically, as shown in FIG. 8, the solder 50 is formed in the shape of a mountain having a slope face 51 that is inclined downward from the center of the pad portion 331 toward the periphery of the pad portion 331. The solder 50 is in contact with substantially the entire region of the surface of the pad portion 331. The slope face 51 of the solder 50 is in the shape of an arch bulging upward, and the entire solder 50 is in the shape of a dome. The solder 50 is cooled to solidify.

At this time, it is preferable that the distance from the surface of the pad portion 331 to the highest position (a vertex 52) of the solder 50 (the thickness of the solder 50) be greater than the base height h2 (see FIG. 9) described below, and be equal to or greater than the wire diameter of the coil wire 40.

Next, the wire arrangement step of arranging an end portion of the coil wire 40 above the base 30 is performed.

In the wire arrangement step, one end portion (a fixed portion 43) of the coil wire 40 is fixed to the wire fixation portion 312, and a part (a portion 42 to be arranged above the pad portion) of the coil wire 40 is arranged above the brazing material 50 provided on the surface of the pad portion 331.

Specifically, as shown in FIGS. 6 and 7, one end of the coil wire 40 drawn from the antenna portion 20, which has the coil wire 40 wound thereon, is drawn toward the circuit portion 33. The thus drawn coil wire 40 is arranged along the inclined face 33c, the upper face 33a of the circuit portion 33, and the outer side face 335a of each guide member 335 as described above. As the coil wire 40 is arranged along the round face of the outer side face 335a of each guide member 335, the direction in which the coil wire 40 is drawn is changed inward. Accordingly, the coil wire 40 is drawn toward the pad portion 331.

As shown in FIG. 7, a partial length region (the portion 42 to be arranged above the pad portion) of the coil wire 40 is arranged above the pad portion 331. Herein, the phrase “a partial length region of the coil wire 40 is arranged above the pad portion 331” means that a part of the coil wire 40 overlaps a part of the pad portion 331 as seen in the height direction. It is preferable that a part of the portion 42 to be arranged above the pad portion be arranged on the outer side of the vertex 52 (see FIG. 8).

In the present embodiment, as shown in FIG. 8, a part of the portion 42 to be arranged above the pad portion is arranged above the pad portion 331, and is not in contact with the surface of the pad portion 331. The solder 50 and the portion 42 to be arranged above the pad portion may or may not be in contact with each other.

As shown in FIG. 6, after the portion 42 to be arranged above the pad portion is arranged above the pad portion 331, an end portion of the coil wire 40 is tied up to the wire fixation portion 312, and thus is fixed thereto. At this time, sufficient tension is applied to the coil wire 40 arranged above the base 30 so that the coil wire 40 does not become loose.

In the present embodiment, the base 30 includes the support portion 311 that changes the direction in which the coil wire 40 is drawn as the coil wire 40 is pressed against the support portion 311. In the wire arrangement step, as shown in FIG. 7, a bent portion 45 located between a part (the portion 42 to be arranged above the pad portion) and one end portion (the fixed portion 43) of the coil wire 40 is pressed against the support portion 311 of the base 30, and thus bends. The bent portion 45 is a part of a length region of the coil wire 40 between the portion 42 to be arranged above the pad portion and the fixed portion 43. More specifically, the bent portion 45 includes a length region of the coil wire 40 that is in contact with the support portion 311 and thus curves, and its neighboring length region.

The support portion 311 is a member for holding the coil wire 40 to maintain the direction in which the coil wire 40 is drawn. Examples of the support portion 311 include a cylindrical protruding portion protruding upward from the upper face 315a of the flat plate portion 315 as shown in FIG. 6. As described below, the direction in which the coil wire 40 drawn from each guide member 335 is drawn is maintained at a predetermined angle as the inner side of the coil wire 40 is brought into pressure contact with the support portion 311. The support portion 311 may also be a prism or a semicylindrical protruding portion having a semicircular bottom face. Alternatively, the support portion 311 may be a wall portion having a peripheral face or plane with which the coil wire 40 is adapted to come into contact, and protruding from the base 30. The shape of the support portion 311 is not limited to the foregoing shapes as long as the support portion 311 has a structure for maintaining the direction in which the coil wire 40 is drawn.

In the present embodiment, the support portion 311 is arranged between the pad portions 331 and the wire fixation portion 312. That is, the support portion 311 is arranged between the portion 42 to be arranged above the pad portion and the fixed portion 43 as seen in the height direction. Such an arrangement allows the bent portion 45 located between the portion 42 to be arranged above the pad portion and the fixed portion 43 to be pressed against a side face of the support portion 311, and thus bend. Specifically, a part of the bent portion 45 is arranged along the peripheral face of the support portion 311, and thus curves. At this time, the coil wire 40 is pressed against the side face of the support portion 311. More specifically, the coil wire 40 is pressed against the side face of the support portion 311 in the left-right direction on the side opposite to the side where the coil wire 40 is drawn from the coil portion 49. For example, as shown in FIG. 7, a coil wire 40b (see FIG. 1) drawn from the coil portion 49 to the base 30 on the right side is pressed against the peripheral face on the left side of the support portion 311.

One end portion (the fixed portion 43) of the coil wire 40, which is bent at the bent portion 45, is tied up to the wire fixation portion 312 of the base 30 as described above.

In the present embodiment, the opposite end portions of the coil wire 40 are arranged above the base 30 as described above. In addition, the both end portions of the coil wire 40 cross each other above the base 30 as seen in the height direction. Specifically, pressurized portions 44 cross each other above a pressure jig placement hole 313 as seen in the height direction. The pressurized portions 44 may or may not be in contact with each other. That is, the pressurized portions 44 may have a twisted relationship with each other. In this manner, as parts of the coil wire 40 cross each other at a single point as seen in the height direction, it becomes possible to, when a pressure jig 200 is placed as described below, easily place a wire bridging portion 220 on the opposite end portions of the coil wire 40.

Note that the pressurized portions 44 of the two coil wires 40a and 40b overlap at the foregoing crossing point in the height direction. The coil wire 40a may be located either above or below the coil wire 40b at the crossing point. In FIGS. 8 and 9, a view of the pressurized portions 44 of the coil wires 40a and 40b that overlap each other is not shown.

As a part of the coil wire 40 is pressed against the support portion 311 as described above, the coil wire 40 drawn from the antenna portion 20 can be drawn in any given direction, and thus can be arranged above the pad portion 331. Specifically, changing the position of the support portion 311 in the front-rear direction, or changing the width (the length in the left-right direction) of the support portion 311 can adjust the position of the coil wire 40 such that it passes through a given position to be arranged. For example, when the support portion 311 is arranged closer to the front end side, or when the width of the support portion 311 is increased, the coil wire 40 is drawn at a larger angle with respect to the front-rear direction, and thus is arranged on the more inner side above the circuit body 333.

In the present embodiment, the distance between the pad portion 331 and the support portion 311 is equal to or less than a half of the distance between the pad portion 331 and the wire fixation portion 312. In addition, the width of the support portion 311 (or the diameter of the bottom face of the support portion 311 if it is a cylinder) is greater than the width of the wire fixation portion 312.

In the wire arrangement step, when the coil wire 40 is arranged on the base 30, the pressurized portion 44 is pressurized against the base 30 so that the coil wire 40 is brought into pressure contact with the brazing material 50 (the solder 50). The pressurized portion 44 is a partial length region of the coil wire 40 between one end portion (the fixed portion 43) thereof and a part (the portion 42 to be arranged above the pad portion) thereof. More specifically, the pressurized portion 44 is a partial length region between the length region of the coil wire 40 in contact with the support portion 311 (a part of or the entirety of the bent portion 45) and the portion 42 to be arranged above the pad portion, and is a partial length region arranged above the pressure jig placement hole 313 described below.

The direction in which the pressurized portion 44 is pressurized against the base 30 is, when the base 30 is provided with a cavity portion such as the pressure jig placement hole 313, a direction toward the pressure jig placement hole 313. In the present embodiment, the pressurized portion 44 is pressurized downward. Accordingly, the coil wire 40 comes into contact with the solder 50 while giving reaction to the solder 50. As described below, the coil wire 40 gives the slope face 51 of the solder 50 reaction acting in the downward direction, in the inward direction, and toward the front end.

To pressurize the pressurized portion 44, the pressure jig 200 is used in the present embodiment.

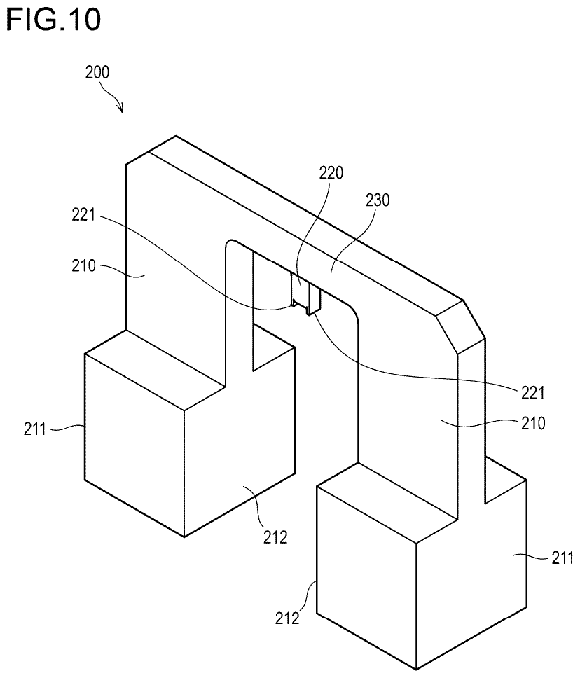

As shown in FIG. 10, the pressure jig 200 has an inverted U-shape as a whole. The pressure jig 200 includes a beam portion 230. Each of the opposite end portions of the beam portion 230 has an arm 210 extending therefrom, and the lower end of the arm 210 is provided with a weight portion 211. The beam portion 230 and the arm 210 of the present embodiment are each shaped like a flat plate, and the weight portion 211 is substantially cubic in shape. The center of the beam portion 230 in its extension direction is provided with the wire bridging portion 220. The wire bridging portion 220 is a portion that directly pressurizes a part (the pressurized portion 44) of the coil wire 40, and includes a pair of claws 221 spaced apart in the extension direction of the beam portion 230. The claws 221 protrude to the side (downward) opposite to the beam portion 230.

The shape of the pressure jig 200 is not limited to the foregoing shape, and any shape of the pressure jig 200 that can pressurize the coil wire 40 is acceptable.

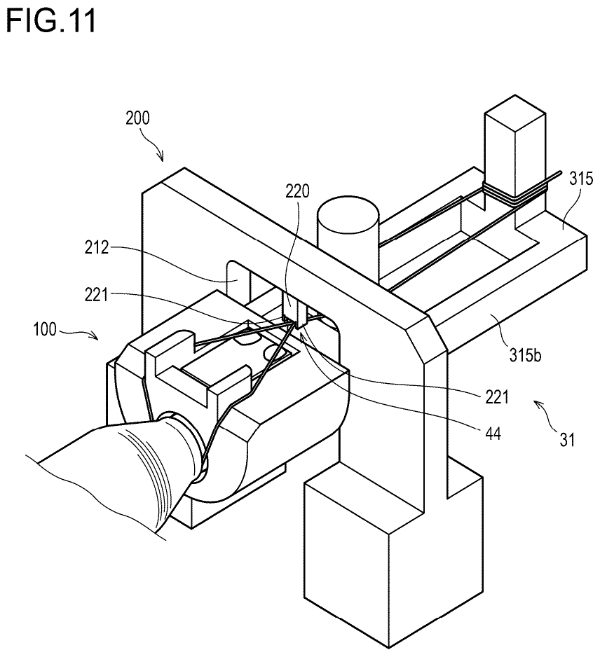

As shown in FIG. 11, the pressure jig 200 is placed to stride across the wire arrangement portion 31. The pressurized portion 44 is arranged between the pair of claws 221, and thus, the wire bridging portion 220 comes into contact with the pressurized portion 44 as it rides and strides across the pressurized portion 44. Specifically, the wire bridging portion 220 rides and strides across a portion of the pressurized portion 44 where the opposite ends of the coil wire 40 are located close to each other or cross each other as seen in the height direction. The pressure jig 200 placed above the pressurized portion 44 sinks downward under its own weight. At this time, the wire bridging portion 220 that has sunk may be placed within the pressure jig placement hole 313, and further, the lower face of the beam portion 230 may or may not be in contact with the upper face of the flat plate portion 315.

As the weight of the pressure jig 200 is transmitted to the pressurized portion 44 in contact with the wire bridging portion 220, the pressurized portion 44 is pressurized downward. At this time, the pressure jig 200 is stably placed on the coil wire 40 as the pressurized portion 44 is held between the pair of claws 221.

The distance between a pair of inner end faces 212 (see FIG. 10) of the pressure jig 200 is equal to or greater than the width of the flat plate portion 315. Preferably, the distance between the inner end faces 212 of the pressure jig 200 is equal to the width of the flat plate portion 315. Thus, when the pressure jig 200 is placed to ride and stride across the coil wire 40, outer end faces 315b of the flat plate portion 315 come into contact with the respective inner end faces 212 of the pressure jig 200. This allows for the easy positioning of the pressure jig 200 when it is placed to ride and stride across the wire arrangement portion 31, and can favorably prevent the displacement of the pressure jig 200 that has ridden and stridden across the wire arrangement portion 31.

As the pressurized portion 44 is pressurized against the base 30, the coil wire 40 warps toward the base 30, that is, downward. Accordingly, the portion 42 to be arranged above the pad portion becomes closer to the pad portion 331, and thus comes into contact with the solder 50, which has been supplied onto the pad portion 331 in advance, while being pressed against the solder 50. More specifically, as shown in FIG. 8, the coil wire 40 is in pressure contact with the slope face 51 of the brazing material 50 (the solder 50). Specifically, the coil wire 40 is in pressure contact with the slope face 51 on the outer side of the vertex 52 of the solder 50 formed in the shape of a mountain. In more detail, the coil wire 40 including the portion 42 to be arranged above the pad portion is pushed out to the outer side at a portion in pressure contact with the solder 50 as seen from above as in FIG. 7, and thus slightly curves. In addition, a part of the coil wire 40 including the portion 42 to be arranged above the pad portion is arranged obliquely with respect to the front end direction as seen from above as in FIG. 7. Therefore, the coil wire 40 including the portion 42 to be arranged above the pad portion is also pushed out toward the rear end at a portion in pressure contact with the solder 50. That is, the portion 42 to be arranged above the pad portion warps outward and also toward the rear end along the slope face of the solder 50 as seen from above as in FIG. 7.

In sum, the coil wire 40 gives the solder 50 not only reaction acting in the downward direction but also reaction acting in the inward direction and toward the front end. That is, the coil wire 40 is in pressure contact with the slope face 51 of the solder 50 toward the center of the pad portion 331 while giving the slope face 51 of the solder 50 reaction (reaction T (see FIG. 8)) acting toward the center of the pad portion 331.

In this manner, as the coil wire 40 is brought into pressure contact with the slope face 51 of the solder 50, the direction of pressure applied to the solder 50 by the coil wire 40 can be controlled to be constant. In addition, as the coil wire 40 comes into contact with not the vertex 52 of the solder 50 but the slope face 51 of the solder 50, unexpected displacement of the coil wire 40 in the left-right direction or the front-rear direction on the solder 50 can be prevented.

As shown in FIG. 9, the upper face 333a of the circuit body 333 is located at a level lower than the upper face 33a of the circuit portion 33. That is, the upper face 333a of the circuit body 333 is located at a level lower than the upper face 33a of the circuit portion 33 that is arranged closer to the rear end side than the circuit body 333.

The height (the base height h2) of the upper face 33a of the circuit portion 33 with reference to the upper face 333a of the circuit body 333 is greater than the thickness of the pad portion 331 as described above. As the upper face 333a of the circuit body 333 is located at a level lower than the upper face 33a of the circuit portion 33, the coil wire 40 comes into contact with the upper face 33a on the rear end side of the circuit portion 33, and does not come into contact with the surface of the pad portion 331 or the circuit portion 33 when the coil wire 40 is pressurized downward. Accordingly, damage to the surface of the pad portion 331 or the circuit portion 33 by the coil wire 40 can be prevented.

In addition, the base height h2 is smaller than the height (solder height h1) of the highest point of the solder 50 with reference to the upper face 333a of the circuit body 333. Preferably, the base height h2 is equal to or less than a half of the solder height h1. Accordingly, the height of the portion 42 to be arranged above the pad portion with respect to the solder 50 can be adjusted to any position. That is, bringing the coil wire 40 into pressure contact with the middle of the slope face 51 of the solder 50 can sufficiently immerse the coil wire 40 in the solder 50 when the solder 50 melts as described below.

After the wire arrangement step, the melting step is performed.

In the melting step, the solder 50 supplied onto the pad portion 331 is irradiated with a laser beam (not shown in the drawings) from above as described above. In the present embodiment, the solder 50 is irradiated with a carbon dioxide gas laser beam. Herein, the phrase “onto the pad portion 331” includes a space on the surface of the pad portion 331 and above the pad portion 331. That is, the phrase “the brazing material 50 supplied onto the pad portion 331 is irradiated with a laser beam” is not limited to a case where the solder 50 that has been formed on the surface of the pad portion 331 and has solidified is irradiated with a laser beam. As described below, a case where the solder 50, such as wire solder arranged above the pad portion 331, is irradiated with a laser beam is also included. The solder 50 melts with the heat provided thereto from the laser beam.

It is acceptable as long as the solder 50 is irradiated with a laser beam, and the coil wire 40 may or may not be irradiated with the laser beam.

In the present embodiment, in the melting step, the solder 50 is supplied to the surface of the pad portion 331 such that the thickness of the supplied solder 50 becomes equal to or greater than the wire diameter of the coil wire 40. In the present embodiment, the solder 50 is formed to attain a thickness equal to or greater than the wire diameter of the coil wire 40 in advance, and the thickness of the solder 50 is maintained equal to or greater than the wire diameter of the coil wire 40 even after the solder 50 is melted by the laser beam.

As described below, when the solder 50 is supplied using wire solder, for example, in the melting step, the thickness of the solder 50 that has been melted and applied to the surface of the pad portion 331 is equal to or greater than the wire diameter of the coil wire 40.

In this manner, as the solder 50 is applied to the surface of the pad portion 331 to attain a sufficient thickness, the coil wire 40 is sufficiently immersed in the solder 50 in the removal step described below.

In the present embodiment, in the melting step, the temperature of at least one of the coil wire 40 or the brazing material 50 (the solder 50) is measured, and an irradiation amount of the laser beam is controlled to allow the temperature to be in a predetermined range higher than the melting point of the brazing material 50. Alternatively, an irradiation amount of the laser beam is controlled to allow the temperature to be in a predetermined range higher than the decomposition temperature of the insulating film 46.

The temperature may be measured for only the coil wire 40, only the brazing material 50, or both the coil wire 40 and the brazing material 50. More specifically, the temperature of the brazing material 50 irradiated with a laser beam, or a part of the coil wire 40 immersed in the brazing material 50 as well as its neighboring length region is measured. The temperature is preferably measured without contact with the solder 50. Examples of a measuring instrument used to measure the temperature include an infrared radiation thermometer.

Herein, the lower limit of the predetermined range is the melting point of the solder 50, and is preferably higher than the melting point of the insulating film 46, and is further preferably higher than the decomposition temperature of the insulating film 46. Meanwhile, the upper limit of the predetermined range may be the lower limit of temperatures at which the insulating film 46 of the coil wire 40 at a portion (an exterior region described below) not immersed in the solder 50 gets burned or decomposes to undergo alteration.

When the temperature of the measured portion has become outside of the predetermined range, an irradiation amount of the laser beam is immediately changed. Herein, the phrase “an irradiation amount of the laser beam is controlled” includes a case where an irradiation amount of the laser beam is increased when the temperature of the measured portion is lower than the predetermined range, and also includes a case where an irradiation amount of the laser beam is decreased or the laser beam irradiation is interrupted when the temperature of the measured portion is higher than the predetermined range.

Controlling the laser beam irradiation in the foregoing manner can sufficiently melt the solder 50, and can heat the insulating film 46 to a temperature that is sufficiently high to remove the insulating film 46 in the removal step described below. Further, it is also possible to prevent the alteration of the insulating film 46 covering the exterior region described below of the coil wire 40.

After the melting step, the removal step is performed.

When the solder 50 has melted to become a liquid state, the coil wire 40 in pressure contact with the solder 50 is partially immersed in the molten solder 50.

The coil wire 40 that has been in pressure contact with the solder 50 toward the center of the pad portion 331 as described above enters the inside of the solder 50 toward the center of the pad portion 331. Specifically, when seen in the front-rear direction as shown in FIG. 8, the coil wire 40 (in particular, the portion 42 to be arranged above the pad portion) in pressure contact with the slope face 51 of the solder 50 enters the inside of the solder 50 while moving inward and downward (the coil wire 40a moves to the lower right side, and the coil wire 40b moves to the lower left side). Meanwhile, when seen from above as in FIG. 7, the coil wire 40 enters the inside of the solder 50 while moving inward and toward the front end (the coil wire 40a moves toward the lower right side on the sheet surface, and the coil wire 40b moves toward the lower left side on the sheet surface).

In other words, the molten solder 50 surrounds the coil wire 40 from the side of the central portion of the pad portion 331. Specifically, in FIG. 8, the solder 50a surrounds the coil wire 40a from its lower right side, and the solder 50b surrounds the coil wire 40b from its lower left side. Accordingly, a part (the upper right portion on the sheet surface) of a side peripheral face 40e (see FIG. 5) of the coil wire 40b is arranged outside of the solder 50b as described below. Alternatively, a part of the coil wire 40 is completely immersed in the solder 50 like the coil wire 40a.

The liquid-state solder 50 supplied to the surface of the pad portion 331 attempts to spread in the lateral direction (the left-right direction and the front-rear direction) as the coil wire 40 is immersed in the molten solder 50. In the present embodiment, the solder 50 spreads only on the surface of the highly wettable pad portion 331, and does not spread to the outer side of the pad portion 331.

As described above, the coil wire 40 enters the inside of the solder 50 while moving inward and toward the front end as seen from above. Accordingly, the solder 50 is pushed out inward and toward the front end, in particular.

Meanwhile, as described above, the pad portion 331 has the shape of a rectangle with a missing corner on the inner side and on the front end side as seen from above. Accordingly, when the coil wire 40 is immersed in the solder 50, the solder 50, which attempts to spread inward and toward the front end, can be prevented from spreading flat more than necessary. Further, the solder 50, which is prevented from spreading, bulges upward and thus attempts to cover the coil wire 40. Thus, an upper peripheral face 40c (see FIG. 5) of the coil wire 40 is covered with the solder 50. This allows the coil wire 40 to be sufficiently immersed in the solder 50.

Note that as described above, the solder 50 is unlikely to wet and spread on the upper face 333a of the circuit body 333 that is not plated with a metal. Thus, the solder 50 bulges upward on the pad portion 331. The thus bulging solder 50 is shaped rounded due to surface tension, and thus may look as if it is arranged on the outer side of the pad portion 331 when seen from above as shown in FIG. 4.

When the coil wire 40 is immersed in the solder 50 heated to a high temperature by laser beam irradiation, the insulating film 46 on the surface of the coil wire 40 immersed in the solder 50 is heated with the heat of the molten solder 50. By the heating, the insulating film 46 in contact with the solder 50 is removed.

Specifically, for example, the insulating film 46 is decomposed to be removed from the coil wire 40. When the temperature of the insulating film 46 has reached the decomposition temperature of the insulating film 46, the insulating film 46 is decomposed. The affinity between the coil core 47 made of a metal material or the like and the solder 50 is higher than the affinity between the decomposition product of the insulating film 46 formed of resin or the like and the coil core 47. Accordingly, the solder 50 wets the surface of the coil core 47, and the decomposition product of the insulating film 46 is removed from the surface of the coil core 47 to the outside of the solder 50. The decomposition product of the insulating film 46 deposits on the surface of the solder 50. Alternatively, the decomposition product of the insulating film 46 sublimes with the heat of the molten solder 50. In this manner, the insulating film 46 is decomposed to be removed from the surface of the coil wire 40, thus exposing the coil core 47.

Alternatively, the insulating film 46 may melt instead of being decomposed, and thus be removed from the coil wire 40. When the temperature of the insulating film 46 has reached the melting point of the resin forming the insulating film 46, the insulating film 46 melts, and thus has increased fluidity to become a liquid state. With the solder 50 wetting the surface of the coil core 47, the liquid-state insulating film 46 is pushed out from the surface of the coil core 47, and thus is removed. The liquid-state insulating film 46 rises to the surface of the solder 50.

Further, a part of the insulating film 46 may melt, while another part thereof may be decomposed to be removed from the coil wire 40.

To sufficiently remove the insulating film 46, it is possible to use the coil wire 40 having the low heat-resistance insulating film 46 with a low heat-resistant temperature. Examples of the insulating material include the one having a heat-resistant temperature of equal to or less than 120 degrees Celsius, such as polyurethane. In addition, it is also preferable to use the coil wire 40 having the insulating film 46 that is thin enough to be easily removed.

The insulating film 46 is preferably transparent or white in color, and not colored. This can suppress the laser absorption rate of the insulating film 46, and thus can prevent the direct removal of the insulating film 46 by laser beam irradiation, or prevent the alteration of the insulating film 46 not covered with the solder 50 by laser beam irradiation.

In this manner, the insulating film 46 covered with the solder 50 is removed substantially entirely from the coil wire 40, but the present invention is not limited thereto.

A small amount of the insulating film 46 may remain on a part of the coil wire 40 immersed in the solder 50. For example, as shown in FIG. 4, a part of an interior region described below covered with the solder 50b (a region on the inner side of a first boundary line 48) is also a covered portion 473 described below in which the insulating film 46 remains. This is because the heat of the solder 50b is not sufficiently transmitted to the peripheral portion of the interior region (a portion close to the first boundary line 48). In addition, as described below, a very small amount of the insulating film 46, which has not been decomposed or melted completely, may remain in the central portion of the interior region.

A part of the coil wire 40 outside of the solder 50 may not be covered with the insulating film 46. For example, a part of the insulating film 46 at a position close to the solder 50a in the exterior region described below of the coil wire 40a shown in FIG. 4 is removed, so that an exposed portion 471 described below results. This is because the heat of the molten solder 50 is also transmitted to the insulating film 46 that is located outside of the solder 50 and is close to the solder 50.

After the insulating film 46 is removed from the coil wire 40, the coil core 47 comes into contact with the solder 50. As the metal forming the coil core 47 is alloyed with the metal forming the solder 50, the coil wire 40 and the pad portion 331 are joined.

The molten solder 50 is cooled to solidify.

In the present embodiment, a part of the melting step and a part of the removal step are performed at an overlapped timing. The phrase “performed at an overlapped timing” includes a case where the steps are entirely performed at the same timing, and a case where parts of the steps are performed at the same time. Specifically, when the solder 50 starts to melt in the melting step, the removal step is started so that the coil wire 40 starts to be immersed in the solder 50. That is, the coil wire 40 is immersed in the solder 50 while the solder 50 is melted by a laser beam. The melting step ends by the time the removal step ends.

In the present embodiment, the coil wire 40 is continuously pressurized against the base side before and during the laser beam irradiation. That is, pressurization in the wire arrangement step and a part of the melting step are performed at an overlapped timing. Accordingly, the immersion of the coil wire 40 in the solder 50 occurs at the same time as the melting of the solder 50.

In the present embodiment, in the melting step, an inert gas (not shown in the drawings) is supplied to the brazing material 50 (the solder 50) along the direction in which the coil wire 40 is pressurized. The inert gas is also preferably supplied in the removal step following the melting step. The direction in which the inert gas is supplied is preferably substantially parallel with the direction in which the coil wire 40 is pressurized. That is, in the melting step, the inert gas is supplied to the solder 50 from above. As the inert gas, a gas having low reactivity with the solder 50 is used. Examples of such an inert gas include a noble gas, such as nitrogen and argon.

Supplying the inert gas to the solder 50 can remove the air including oxygen around the solder 50. This can prevent the oxidation of the solder 50, and thus can improve the wettability of the solder 50 on the peripheral face of the coil wire 40 as well as the wettability of the solder 50 on the surface of the pad portion 331.

In addition, supplying the inert gas along the direction in which the coil wire 40 is pressurized can sufficiently remove oxygen in a wide range around the solder 50. That is, since the solder 50 has been supplied in the shape of a mountain such that it protrudes upward, the inert gas is supplied to the entire region of the slope face 51 of the solder 50 if it is supplied from above.

Instead of supplying the inert gas along the direction in which the coil wire 40 is pressurized, it is also possible to supply the inert gas along each of the directions of reaction acting on the solder 50 from the coil wire 40. That is, the inert gas may be supplied in two directions including a direction toward the solder 50 from the upper right side and a direction toward the solder 50 from the upper left side. This allows the inert gas to be sufficiently supplied to a region around the coil wire 40 buried in the solder 50, in particular. Thus, the wettability of the solder 50 on the peripheral face of the coil wire 40 is kept favorably, and the coil wire 40 is thus sufficiently immersed in the solder 50.

The present method includes the cutting step performed after the pad portion 331 and the coil wire 40 are joined with the brazing material 50 (the solder 50) in the removal step. In the cutting step, the coil wire 40 and the base 30 are cut so that a part of the coil wire 40 including its one end portion (the fixed portion 43) and a part of the base 30 including its wire fixation portion 312 are removed.

In the present embodiment, the coil wire 40 and the base 30 are cut along a plane substantially perpendicular to the front-rear direction. Preferably, the coil wire 40 and the base 30 are cut along the same plane.

Specifically, the coil wire 40 and the base 30 are cut along a cutting plane indicated by a dashed and single-dotted line Y in FIG. 9. That is, in the present embodiment, the cutting plane along which the coil wire 40 and the base 30 are cut is a plane that is located closer to the rear end side than a side end face 333b on the rear end side of the circuit body 333, and is parallel with the side end face 333b. More specifically, the cutting plane includes the placement hole 334.

Instead, the cutting plane may be flush with the side end face 333b of the circuit body 333. In addition, the removal step may include cutting the flat plate portion 315 of the wire arrangement portion 31 and the coil wire 40 without cutting the circuit portion 33. In such a case, the cutting plane may be flush with a rear-end side face 33d located on the rear end side of the circuit portion 33 (the boundary plane between the wire arrangement portion 31 and the circuit portion 33).

The opposite end portions of the coil wire 40 located closer to the front end side than the cutting plane are removed. Specifically, each end portion of the coil wire 40 including the pressurized portion 44, the bent portion 45, and the fixed portion 43 is removed. In addition, a part of the base 30 located closer to the front end side than the cutting plane is also removed. Specifically, an end portion of the base 30 including the wire arrangement portion 31 is removed.

The antenna device 100 is manufactured through the foregoing steps.

To manufacture the antenna device 100, the melting step of melting the solder 50 through laser beam irradiation and the step of removing a part of the insulating film 46 from the coil wire 40 by immersing the coil wire 40 in the molten solder 50 are the essential steps. Any other steps or any other components may be optionally included.

According to the present method, when the coil wire 40 is immersed in the solder 50 for soldering purposes, the insulating film 46 is removed from the coil wire 40. That is, according to the present method, it is possible to remove the insulating film 46 during the brazing step, and thus can eliminate the need to perform a step of removing the insulating film 46 of the coil wire 40 before the brazing step. This can reduce the manufacturing steps for the antenna device 100.

### (Details of Antenna Device)

Next, the features of the antenna device 100 manufactured in the present embodiment will be described in detail.

The coil wire 40 includes the exposed portion 471 in which the coil core 47 is uncovered with the insulating film 46 and thus is exposed. On the peripheral face of the coil wire 40, the first boundary line 48, which is the boundary between the interior region buried in the solder 50 and the exterior region outside of the solder 50, and a second boundary line 472, which is the boundary between the exposed portion 471 and the covered portion 473 of the coil wire 40 covered with the insulating film 46, are arranged along each other.

The phrase “a part of the peripheral face of the coil wire 40 is buried in the solder 50” means that a part of a face of the peripheral face of the coil wire 40 is covered with the solder 50.

The interior region is a partial region, buried in the solder 50, of the peripheral face of the coil wire 40, which is a region on the inner side of the first boundary line 48 (see FIG. 4). Meanwhile, the exterior region is a partial region, not covered with the solder 50, of the peripheral face of the coil wire 40, which is a region on the outer side of the first boundary line 48.

As shown in FIG. 4, two first boundary lines 48 are arranged spaced apart in the front-rear direction on the peripheral face of the coil wire 40a. Each first boundary line 48 on the coil wire 40a surrounds the coil wire 40a in the circumferential direction. Herein, the interior region (the region on the inner side of the first boundary line 48) is a part of a region on the peripheral face of the coil wire 40a interposed between the pair of first boundary lines 48. That is, the interior region of the coil wire 40a is located across the entire portion of the coil wire 40a in the radial direction.

Meanwhile, a single first boundary line 48, which has a substantially elliptical shape, is arranged on the peripheral face of the coil wire 40b shown in FIG. 4. The interior region of the coil wire 40b is a substantially elliptical region within the first boundary line 48. More specifically, in the interior region of the coil wire 40b, the peripheral face on the lower side (a lower peripheral face 40d described below) of the coil wire 40b is partially covered, and such a region is located across only a part of the coil wire 40b in the radial direction.

The exposed portion 471 is a partial region of the peripheral face of the coil wire 40, and is a region that is not covered with the insulating film 46 and in which the coil core 47 is exposed. As described above, there may be a case where, in the removal step, the insulating film 46 is not sufficiently removed, and a slight amount of the insulating film 46 thus remains in the central portion of the interior region. That is, the insulating film 46 may be arranged in a small part of the central portion of the exposed portion 471. In such a case, a region in which the insulating film 46 is arranged on the inner side, excluding the periphery, of the interior region is also assumed as the exposed portion 471. Preferably, the insulating film 46 is completely removed in the entire region of the exposed portion 471.

Meanwhile, a partial region, excluding the exposed portion 471, of the peripheral face of the coil wire 40 is covered with the insulating film 46. A region, covered with the insulating film 46, of the peripheral face of the coil wire 40 is assumed as the covered portion 473.

Regarding the coil wire 40a, the exposed portion 471 is located across the entire peripheral face of the coil wire 40a. An exposed portion 471a is a region interposed between a pair of second boundary lines 472a spaced apart in the front-rear direction. Each second boundary line 472a surrounds the peripheral face of the coil wire 40a in the circumferential direction. Meanwhile, regarding the coil wire 40b, an exposed portion 471b has a substantially elliptical shape including a part of the lower peripheral face 40d described below, and is located across only a part of the coil wire 40b in the radial direction. That is, the exposed portion 471b is a region within the second boundary line 472 that has a substantially elliptical shape.

As shown in FIG. 4, the exposed portion 471 and the interior region substantially coincide with each other, but need not completely coincide with each other. For example, the exposed portion 471 may include the exterior region, and the interior region may include the covered portion 473. Regarding the coil wire 40a, the major part of the exposed portion 471 is covered with the solder 50, and thus coincides with the interior region, but a part of the exposed portion 471 is located outside of the solder 50, and thus corresponds to the exterior region. Regarding the coil wire 40b, the greater part of the interior region is the exposed portion 471 in which the coil core 47 is exposed, but the rest of the interior region is the covered portion 473 covered with the insulating film 46.

Herein, the phrase “the first boundary line 48 and the second boundary line 472 are arranged along each other” means that projections and recesses of the first boundary line 48 and those of the second boundary line 472 correspond to each other. That is, the shapes of the first boundary line 48 and the second boundary line 472 are substantially identical. Preferably, an acute angle of the angles made by the tangent to a part of the first boundary line 48 and the tangent to a part of the second boundary line 472, which is located close to the part of the first boundary line 48, is smaller than an acute angle of the angles made by a plane orthogonal to the extension direction of the coil wire 40 and the first boundary line 48.

It is desirable that the first boundary line 48 and the second boundary line 472 be sufficiently close to each other. Specifically, the distance between a part of the first boundary line 48 and a part of the second boundary line 472 located close thereto is preferably equal to or less than the wire diameter of the coil. Further preferably, the distance between a part of the first boundary line 48 and a part of the second boundary line 472 located close thereto is zero. In such a case, the first boundary line 48 and the second boundary line 472 substantially coincide with each other.

The first boundary line 48 may be arranged either inside or outside of the exposed portion 471. For example, a first boundary line 48a for the solder 50a is present on the exposed portion 471a. That is, the first boundary line 48a is located on the inner side of a second boundary line 472a in the exposed portion 471a. Meanwhile, a partial length region (a first boundary line 48b) of the first boundary line 48 for the solder 50b is arranged outside of the exposed portion 471b. That is, the partial length region (the first boundary line 48b) of the first boundary line 48 is arranged on the outer side of the exposed portion 471b more than a second boundary line 472b. In addition, another partial length region (a first boundary line 48c) of the first boundary line 48 for the solder 50b substantially coincides with a part (a second boundary line 472c) of the second boundary line 472.

Further, the second boundary line 472 and the first boundary line 48 may cross each other. That is, a partial length region of the first boundary line 48 may be arranged on the outer side of the exposed portion 471, while another partial length region of the first boundary line 48 may be arranged on the inner side of the exposed portion 471 so that the second boundary line 472 and the first boundary line 48 may cross each other.

When the solder 50 is formed in a shape that allows the solder 50 to include the coil wire 40 such that the first boundary line 48 and the second boundary line 472 are arranged along each other, the antenna device 100 can be manufactured with the foregoing manufacturing method. That is, the antenna device 100 of the present embodiment is a structure that can be manufactured through a small number of manufacturing steps.

In addition, as the first boundary line 48 and the second boundary line 472 are arranged along each other, substantially the entire region of the exposed portion 471 is covered with the solder 50 so that a region of the exposed portion 471 not covered with the solder 50 (a region where the coil core is exposed) can be minimized. This can prevent the exposure of the coil core 47 more than necessary, and thus can increase the insulation property of the coil wire 40. Further, as the exposure of the coil core 47 is reduced, the degradation of the coil core 47 due to wear or oxidization can be prevented.

Note that the antenna device 100, which has the foregoing configuration in which the coil wire 40 is included in the solder 50 such that the first boundary line 48 and the second boundary line 472 are arranged along each other, can be manufactured independently of the foregoing manufacturing method. For example, the insulating film can be removed in a state where a region of the peripheral face of the coil wire 40 other than a region planned to be covered with the solder 50 is masked in advance.

In the present embodiment, the thickness (the length in the height direction) of the brazing material 50 (the solder 50) is greater than the wire diameter of the coil wire 40. The thickness of the solder 50 herein refers to, in a region where the solder 50 is disposed as seen in the height direction, the maximum height of the solder 50 with reference to the surface of the pad portion 331 at a point where the coil wire 40 and the solder 50 do not overlap. That is, the thickness of the solder 50 herein does not include the thickness of the coil wire 40, and means the thickness of only the solder 50. For example, as shown in FIG. 5, the solder 50 is substantially formed in the shape of a mountain with a vertex located above the coil wire 40. In such a case, the highest position of the solder 50 is present above the coil wire 40, but the thickness of the solder 50 is smaller than the height of the solder 50 (the distance from the surface of the pad portion 331 to the highest position of the solder 50). In such a case, the thickness of the solder 50 corresponds to the height of the solder 50 at a point close to the lateral side of the coil wire 40.

As the solder 50 is formed such that it has a sufficient thickness that is equal to or greater than the wire diameter of the coil wire 40, the coil wire 40 can be sufficiently immersed in the solder 50 in the method for manufacturing the antenna device 100 described below.

In addition, as the solder 50 is supplied to attain a thickness equal to or greater than the wire diameter of the coil wire 40, substantially the entire portion of the coil wire 40 in the radial direction can be buried in the solder 50. This allows the solder 50 and the coil wire 40 to be physically joined more firmly, and also allow the solder 50 and the coil wire 40 to be electricity connected more favorably.

In the present embodiment, a part of the coil wire 40b in the radial direction corresponds to the exposed portion 471, while another part thereof in the radial direction corresponds to the covered portion 473 across a partial length region of the coil wire 40b (a buried portion 42a that is a partial length region having the exposed portion 471 as seen in the radial direction of the coil wire 40). The phrase “a part of the coil wire 40b in the radial direction corresponds to the exposed portion 471, while another part thereof corresponds to the covered portion 473” means that regarding a cross-section at a given point of the buried portion 42a, a part of the circumference (arc) of the circle of the cross-section is not covered with the insulating film 46, and the coil core 47 is thus exposed, while another part of the circumference is covered with the insulating film 46.

In the present embodiment, as seen in the coil wire 40b shown in FIGS. 4 and 5, a part of the coil wire 40b in the radial direction corresponds to the exposed portion 471, while another part thereof corresponds to the covered portion 473 across the entire region of the buried portion 42a. That is, the insulating film 46 is not divided by the exposed portion 471.

In other words, a first insulating film 46a and a second insulating film 46b, which respectively cover the entire portions in the radial direction of a first length region and a second length region sandwiching the buried portion 42a (the partial length region buried in the brazing material 50), of the coil wire 40, are connected by a bridge portion 461 having a width smaller than the wire diameter of the coil wire 40 and extending along the extension direction of the coil wire 40.

Herein, each of the first length region and the second length region is a region outside of the brazing material 50, and is a partial length region of the coil wire 40 located closer to the front end side or the rear end side than the pad portion 331 as seen in the height direction. As shown in FIG. 4, the first insulating film 46a covers the entire periphery of the coil wire 40 (the first length region) located closer to the front end side than the buried portion 42a. Meanwhile, the second insulating film 46b covers the entire periphery of the coil wire 40 (the second length region) located closer to the rear end side than the buried portion 42a.

The bridge portion 461 connecting the first insulating film 46a and the second insulating film 46b is arranged on the peripheral face of the buried portion 42a. The bridge portion 461 is a part of the insulating film 46, has a narrow width, and is long in the direction along the axial direction of the coil wire 40. The longitudinal direction of the bridge portion 461 and the extension direction of the coil wire 40 lie along each other. Herein, the width of the bridge portion 461 refers to the minimum circumferential length of the bridge portion 461. In addition, the phrase “the longitudinal direction of the bridge portion 461 and the extension direction of the coil wire 40 lie along each other” means that an acute angle of the angles obtained by projecting an imaginary center line of the center of the bridge portion 461 in the width direction onto the axis of the coil wire 40 is at least equal to or less than 30 degrees. Preferably, the center line of the bridge portion 461 and the axis of the coil wire 40 are substantially parallel with each other.

Further, in the present embodiment, in the partial length region (the buried portion 42a) of the coil wire 40, each of a part of the upper side (the upper peripheral face 40c) of the coil wire 40 opposite to the side where the pad portion 331 is arranged, and a part of the lower side (the lower peripheral face 40d) of the coil wire 40 facing the pad portion 331 corresponds to the exposed portion 471 from which the insulating film 46 has been removed, and thus is in contact with the brazing material 50. Meanwhile, a part of the lateral side of the coil wire 40 in the partial length region corresponds to the covered portion 473 covered with the insulating film 46, and thus is not in contact with the brazing material 50.

Herein, the upper peripheral face 40c is a region, which has a predetermined width including the upper end of the coil wire 40, of the peripheral face of the buried portion 42a as shown in FIG. 5. That is, the upper peripheral face 40c may be a substantially linear region including only the upper end of the coil wire 40, or may be a long, thin region including the upper end of the coil wire 40 and its periphery. Meanwhile, the lower peripheral face 40d is a region, which has a predetermined width including the lower end of the coil wire 40, of the peripheral face of the buried portion 42a. As with the upper peripheral face 40c, the lower peripheral face 40d may be either a substantially linear region including only the lower end, or a long, thin region having a certain width. The width of the upper peripheral face 40c or the lower peripheral face 40d may be equal to or less than a half of the wire diameter of the coil wire 40, or equal to or greater than a half of the wire diameter of the coil wire 40.

Herein, the phrase “a part of the lateral side of the coil wire 40 corresponds to the covered portion 473” means that at least a part of the side peripheral face corresponds to the covered portion 473. The side peripheral face 40e is a region, excluding the upper peripheral face 40c and the lower peripheral face 40d, of the peripheral face of the coil wire 40.

Further, in the present embodiment, a part of the upper side of the lateral side of the coil wire 40 in the partial length region (the buried portion 42a) corresponds to the covered portion 473 covered with the insulating film 46, and thus is not in contact with the brazing material 50, while the entire lower side of the lateral side of the coil wire 40 in the partial length region (the buried portion 42a) corresponds to the exposed portion 471 from which the insulating film 46 has been removed, and thus is in contact with the brazing material 50. That is, a region on the outer side and the upper side of the side peripheral face 40e corresponds to the covered portion 473, while a region on the lower side of the side peripheral face 40e corresponds to the exposed portion 471. Herein, the upper side of the side peripheral face 40e is a region of the side peripheral face 40e located above the center of the cross-section of the coil wire 40, while the lower side of the side peripheral face 40e is a region located below the center of the cross-section and facing the pad portion 331.

The present invention is not limited to the configuration in which each of the upper peripheral face 40c and the lower peripheral face 40d corresponds to the exposed portion 471 across the entire length region of the buried portion 42a. The upper peripheral face 40c or the lower peripheral face 40d may correspond to the exposed portion 471 across a part of the length region of the buried portion 42a, while the upper peripheral face 40c or the lower peripheral face 40d may correspond to the covered portion 473 across the rest of the length region.

As a part of the coil wire 40 in the radial direction is buried in the solder 50, while another part thereof is arranged outside of the solder 50, the coil wire 40 and the pad portion 331 can be joined with a small amount of the solder 50.

In addition, as a part of the coil wire 40 in the radial direction not covered with the solder 50 is covered with the insulating film 46, the entire periphery of the coil core 47 of the buried portion 42a is covered with the insulating film 46 or the solder 50. Accordingly, the coil core 47 is not exposed to the outside, which can prevent the degradation of the coil core 47 due to oxidization or wear, for example, which would otherwise lead to a break in the coil core 47.

Further, as a part of the coil wire 40 in the radial direction is not covered with the solder 50 across the entire length of the buried portion 42a, the heat-resistance and fatigue characteristics of a joint of the pad portion 331 and the coil wire 40 improve. For example, when the coil wire 40 is immersed in the molten solder 50, air attached to the coil wire 40 may enter the inside of the solder 50. In contrast, according to the present embodiment, as a part of the coil wire 40 in the radial direction is not covered with the solder 50 across the entire length of the buried portion 42a, air that has entered any portion in the solder 50 is likely to move upward along the surface of the coil wire 40, and thus be removed from the solder 50. This can prevent the generation of voids in the solder 50, and thus can prevent the degradation of the joint over time due to shrinkage or expansion of air in the solder 50 with changes in temperature around the joint.

In addition, as the upper peripheral face 40c of the peripheral face of the coil wire 40 is covered with the brazing material 50, the upper peripheral face 40c, which is likely to interfere with other members and thus wear, can be protected with the brazing material 50.

Note that as shown in FIG. 4, the entire portion of the coil wire 40a, buried in the solder 50a, in the radial direction corresponds to the exposed portion 471 from which the insulating film 46 has been removed across substantially the entire length of the buried portion 42a. In the present embodiment, the opposite ends of the coil wire 40a in the buried portion 42a protrude from the solder 50a obliquely with respect to the circumferential direction of the coil wire 40a. The first insulating film 46a, which covers the first length region closer to the front end side than the buried portion 42a of the coil wire 40a, and the second insulating film 46b, which covers the second length region closer to the rear end side than the buried portion 42a, are divided by the exposed portion 471, and thus are spaced apart from each other.

In addition, at a part of each of the opposite ends of the buried portion 42a, only a part of the coil wire 40 in the radial direction corresponds to the interior region covered with the solder 50, while another part thereof in the radial direction corresponds to the exterior region not covered with the solder 50.

In the present embodiment, at each of the opposite ends of the buried portion 42a, a region, which is close to the solder 50a, of the exterior region of the peripheral face of the coil wire 40a corresponds to the exposed portion 471a from which the insulating film 46 has been removed. Instead, a region, which is close to the solder 50a, of the exterior region of the peripheral face of the coil wire 40a may correspond to the covered portion 473 covered with the insulating film 46. That is, the second boundary line 472 and the first boundary line 48 may substantially coincide with each other, or the second boundary line 472 may be arranged on the inner side of the exposed portion 471. In such a case, at each of the opposite ends of the buried portion 42a, a part of the coil wire 40a in the radial direction is covered with the solder 50, while another part thereof in the radial direction is covered with the insulating film 46. This can prevent the degradation of the coil core 47 due to wear or oxidization, for example, which would otherwise lead to a break in the coil core 47 as described above at the opposite ends of the buried portion 42a.

Although the present embodiment illustrates a configuration in which a part of only one of the left and right coil wires 40a and 40b in the radial direction corresponds to the exposed portion 471, while another part thereof corresponds to the covered portion 473 across the entire length region of the buried portion 42a, the present invention is not limited thereto. That is, a part of each of the left and right coil wires 40a and 40b in the radial direction may correspond to the exposed portion 471, while another part thereof may correspond to the covered portion 473 across the entire length region of the buried portion 42a. Alternatively, the entire portion of each of the left and right coil wires 40a and 40b in the radial direction may correspond to the exposed portion 471 across the partial length region.

In the present embodiment, as shown in FIGS. 2 and 3, an end face 41 of each of the opposite ends of the coil wire 40 and a side end face 33b of the base 30 (the circuit portion 33) are arranged flush with each other. Herein, the end face 41 of the coil wire 40 is a cross-section that occurs as the coil wire 40 is cut in the foregoing cutting step. In the present embodiment, the coil wire 40 is arranged obliquely with respect to the cutting plane. Thus, each end face 41 of the coil wire 40 is elliptical. Meanwhile, the side end face 33b of the circuit portion 33 herein is a face that is opposite the rear end side of the circuit portion 33, and is a cross-section that occurs as the base 30 is cut in the foregoing cutting step. That is, the side end face 33b of the circuit portion 33 is flush with a plane indicated by the dashed and single-dotted line Y in FIG. 9.

Instead of the present embodiment, it is also possible to cut the coil wire 40 and the circuit portion 33 at a plane along the side end face 333b of the circuit body 333 in the cutting step. In such a case, the end face 41 of the coil wire 40, the side end face 33b of the circuit portion 33, and the side end face 333b of the circuit body 333 are all arranged flush with each other. Alternatively, it is also possible to cut the base 30 along the same plane as the boundary plane between the circuit portion 33 and the wire arrangement portion 31 (the same plane as the rear-end side face 33d in FIG. 9) in the cutting step.

In this manner, as the coil wire 40 and the circuit body 333 do not protrude toward the rear end beyond the side end face 33b of the circuit portion 33, the degradation of the coil wire 40 and the circuit body 333 due to wear can be prevented.

### MODIFIED EXAMPLES

Note that the present invention is not limited to the foregoing embodiment, and includes various modifications, improvements, and the like within the range that the object of the present invention is achieved.

The following modified examples can be combined as appropriate.

For example, although the solder 50 is formed in advance in the shape of a mountain on the surface of the pad portion 331 and is then solidified in the present embodiment, the present invention is not limited thereto. The solder 50 need not be formed in advance on the surface of the pad portion 331. For example, as described above, the solder 50 supplied to a region above the pad portion 331 may be melted with a laser beam in the melting step so that the molten solder 50 falls onto the surface of the pad portion 331. When the solder 50 is not formed in advance on the surface of the pad portion 331 but the solder 50 melted in the melting step is applied onto the surface of the pad portion 331, the wire arrangement step may be performed after the melting step. That is, it is possible to supply the solder 50 in a liquid state onto the surface of the pad portion 331, and then arrange the coil wire 40 above the pad portion 331, and further pressurize the coil wire 40 downward so as to allow the coil wire 40 to be immersed in the solder 50. That is, the melting step and the removal step may be performed at different timings.

Although the solder 50 is formed in advance on the surface of the pad such that the resulting slope face 51 has the shape of an arch-like mountain in the present embodiment, the present invention is not limited thereto. For example, the slope face 51 of the solder 50 may be a straight line or be recessed downward. In addition, the vertex 52 of the solder 50 need not be a point. The highest point of the solder 50 may form a continuous line or a plane. For example, the solder 50 may be formed in a trapezoidal shape as seen in the front-rear direction.

In the present embodiment, to bring the coil wire 40 into pressure contact with the solder 50, one end of the coil wire 40 is fixed to the rear end side of the base 30, and the pressure jig 200 is placed on the coil wire 40 to pressurize the coil wire 40 downward, but the present invention is not limited thereto. For example, it is also possible to bring the coil wire 40 into pressure contact with the solder 50 by placing the coil wire 40 close to the solder 50 using a mechanism for pulling or pushing the coil wire 40 downward without the use of the pressure jig. Besides, it is also possible to, when the coil wire 40 is arranged above the pad portion 331 and is then drawn toward the rear end in the wire arrangement step, draw the coil wire 40 downward and fix it in place so as to allow it to be in pressure contact with the solder 50.

As described above, in the present embodiment, the depth (the length in the height direction) of the placement hole 334 is greater than the thickness (the length in the height direction) of the circuit body 333 so that the entire upper face 33a of the circuit portion 33 is arranged at a position higher than the upper face 333a of the circuit body 333. Instead of the present embodiment, it is also possible to arrange only a portion of the upper face 33a of the circuit portion 33, which is located on the rear end side of the circuit body 333, at a position higher than the upper face 333a of the circuit body 333. For example, a protruding portion, which protrudes upward from the upper face 33a of the circuit portion 33, may be provided at a position closer to the rear end side than the circuit body 333 so that the upper face of the protruding portion is located higher than the upper face 333a of the circuit body 333. Accordingly, the coil wire 40, which moves closer to the pad portion 331 by being pressurized, can be prevented from coming into contact with the pad portion 331, which would otherwise damage the pad portion 331. In such a case, substantially the entire region of the upper face 33a of the circuit portion 33 excluding the protruding portion may be arranged at a position lower than the upper face 333a of the circuit body 333.

In the present embodiment, the pressure jig placement hole 313 is arranged between the circuit portion 33 and the support portion 311, but the present invention is not limited thereto. The pressure jig placement hole 313 may be provided between the support portion 311 and the wire fixation portion 312. In such a case, the pressurized portion 44 corresponds to a partial length region between the bent portion 45 and the fixed portion 43.

The foregoing embodiments encompass the following technical ideas.

(1) A method for manufacturing an antenna device, the antenna device including an antenna portion formed by winding a coil wire having a coil core covered with an insulating film, and a base having a pad portion to which a part of the coil wire is brazed with a brazing material, the method comprising:
melting the brazing material by irradiating the brazing material supplied onto the pad portion with a laser beam; and
removing a part of the insulating film from the coil wire by immersing the coil wire in the molten brazing material, thereby joining the coil wire and the pad portion with the brazing material.

(2) The method for manufacturing the antenna device according to (1), wherein melting the brazing material and removing the part of the insulating film are performed at an overlapped timing.

(3) The method for manufacturing the antenna device according to (1) or (2), wherein in melting the brazing material, the brazing material is supplied to a surface of the pad portion such that a thickness of the supplied brazing material becomes equal to or greater than a wire diameter of the coil wire.

(4) The method for manufacturing the antenna device according to any one of (1) to (3), wherein in removing the insulating film, the insulating film is decomposed to be removed from the coil wire.

(5) The method for manufacturing the antenna device according to any one of (1) to (4), wherein melting the brazing material includes:
measuring a temperature of at least one of the coil wire or the brazing material and
controlling an irradiation amount of the laser beam to allow the temperature to be in a predetermined range higher than a melting point of the brazing material.

(6) The method for manufacturing the antenna device according to (5), wherein an irradiation amount of the laser beam is controlled to allow the temperature to be in a predetermined range higher than a decomposition temperature of the insulating film.

(7) The method for manufacturing the antenna device according to any one of (1) to (6), the method further comprises arranging the coil wire performed before melting the brazing material,
wherein:
the base includes a wire fixation portion adapted to have the coil wire fixed to the wire fixation portion,
in arranging the coil wire, one end portion of the coil wire is fixed to the wire fixation portion, and a part of the coil wire is arranged above the brazing material provided on a surface of the pad portion, and
in arranging the coil wire, a pressurized portion that is a partial length region between the one end portion and the part of the coil wire is pressurized against the base so that the coil wire is brought into pressure contact with the brazing material.

(8) The method for manufacturing the antenna device according to (7), wherein in arranging the coil wire, the brazing material has been formed on the surface of the pad portion such that the brazing material has a shape of a mountain having a slope face that is inclined downward from a center of the pad portion toward a periphery of the pad portion and the coil wire is brought into pressure contact with the slope face of the brazing material.

(9) The method for manufacturing the antenna device according to (8), wherein the coil wire is brought into pressure contact with the slope face toward the center of the pad portion.

(10) The method for manufacturing the antenna device according to any one of (7) to (9), the method further comprises:
cutting the coil wire and the base to remove a part of the coil wire including the one end portion and a part of the base including the wire fixation portion after the pad portion and the coil wire are joined with the brazing material.

(11) The method for manufacturing the antenna device according to any one of (7) to (10),
wherein:
the base includes a support portion that changes a direction in which the coil wire is drawn as the coil wire is pressed against the support portion,
in arranging the coil wire, a bent portion located between the part and the one end portion of the coil wire is pressed against the support portion of the base and thus bends, and
the one end portion of the coil wire bent at the bent portion is tied up to the wire fixation portion of the base.

(12) The method for manufacturing the antenna device according to any one of (7) to (11), wherein in melting the brazing material, an inert gas is supplied to the brazing material along a direction in which the coil wire is pressurized.

(13) An antenna device comprising:
an antenna portion formed by winding a coil wire having a coil core and an insulating film covering the coil core; and
a base including a pad portion,
wherein:
the coil wire includes an exposed portion of the coil core that is uncovered with the insulating film and thus is exposed,
the coil wire and the pad portion are joined with a brazing material,
a part of the coil wire is buried in the brazing material, and
a first boundary line and a second boundary line are arranged along each other, the first boundary line being a boundary between, regarding a peripheral face of the coil wire, an interior region buried in the brazing material and an exterior region located outside of the brazing material, the second boundary line being a boundary between the exposed portion and a covered portion of the coil wire that is covered with the insulating film.

(14) The antenna device according to (13), wherein a thickness of the brazing material is greater than a wire diameter of the coil wire.

(15) The antenna device according to (13) or (14), wherein a part of the coil wire in a radial direction corresponds to the exposed portion, while another part of the coil wire in the radial direction corresponds to the covered portion across a partial length region of the coil wire.

(16) The antenna device according to (15), wherein a part of an upper side of the coil wire opposite to a side where the pad portion is arranged and a part of a lower side of the coil wire facing the pad portion each correspond to the exposed portion, and thus are in contact with the brazing material across the partial length region of the coil wire, while a part of a lateral side of the coil wire corresponds to the covered portion, and thus is not in contact with the brazing material across the partial length region.

(17) The antenna device according to (16), wherein a part of an upper side of the lateral side of the partial length region corresponds to the covered portion, and thus is not in contact with the brazing material, while an entire lower side of the lateral side of the partial length region corresponds to the exposed portion, and thus is in contact with the brazing material.

(18) The antenna device according to any one of (15) to (17), wherein a first insulating film and a second insulating film are connected by a bridge portion having a width smaller than a wire diameter of the coil wire and extending along an extension direction of the coil wire, the first insulating film and the second insulating film respectively covering entire portions in the radial direction of a first length region and a second length region sandwiching the partial length region, buried in the brazing material, of the coil wire. wherein a first insulating film and a second insulating film are connected by a bridge portion having a width smaller than a wire diameter of the coil wire and extending along an extension direction of the coil wire, the first insulating film and the second insulating film respectively covering entire portions in the radial direction of a first length region and a second length region sandwiching the partial length region, buried in the brazing material, of the coil wire.

(19) The antenna device according to any one of (13) to (18), wherein opposite end faces of the coil wire and a side end face of the base are arranged flush with each other.

(20) The antenna device according to any one of (13) to (19),

wherein:
opposite ends of the coil wire are respectively joined to a pair of pad portions provided on the base with the brazing material,
each of the pair of pad portions is formed in a rectangular shape,
each rectangular shape has a shape with an oblique side formed by chamfering a corner on an inner side of each of the pair of pad portions, and
the oblique side lies along an extension direction of the coil wire.

(21) The antenna device in which the insulating film is transparent or white in color.

1. A method for manufacturing an antenna device, the antenna device including an antenna portion formed by winding a coil wire having a coil core covered with an insulating film, and a base having a pad portion to which a part of the coil wire is brazed with a brazing material, the method comprising:
melting the brazing material by irradiating the brazing material supplied onto the pad portion with a laser beam; and
removing a part of the insulating film from the coil wire by immersing the coil wire in the molten brazing material, thereby joining the coil wire and the pad portion with the brazing material.

2. The method for manufacturing the antenna device according to claim 1, wherein melting the brazing material and removing the part of the insulating film are performed at an overlapped timing.

3. The method for manufacturing the antenna device according to claim 1, wherein in melting the brazing material, the brazing material is supplied to a surface of the pad portion such that a thickness of the supplied brazing material becomes equal to or greater than a wire diameter of the coil wire.

4. The method for manufacturing the antenna device according to claim 1, wherein in removing the insulating film, the insulating film is decomposed to be removed from the coil wire.

5. The method for manufacturing the antenna device according to claim 1, wherein melting the brazing material includes:
measuring a temperature of at least one of the coil wire or the brazing material and
controlling an irradiation amount of the laser beam to allow the temperature to be in a predetermined range higher than a melting point of the brazing material.

6. The method for manufacturing the antenna device according to claim 5, wherein an irradiation amount of the laser beam is controlled to allow the temperature to be in a predetermined range higher than a decomposition temperature of the insulating film.

7. The method for manufacturing the antenna device according to claim 1, the method further comprises arranging the coil wire performed before melting the brazing material,
wherein:
the base includes a wire fixation portion adapted to have the coil wire fixed to the wire fixation portion,
in arranging the coil wire, one end portion of the coil wire is fixed to the wire fixation portion, and a part of the coil wire is arranged above the brazing material provided on a surface of the pad portion, and
in arranging the coil wire, a pressurized portion that is a partial length region between the one end portion and the part of the coil wire is pressurized against the base so that the coil wire is brought into pressure contact with the brazing material.

8. The method for manufacturing the antenna device according to claim 7, wherein in arranging the coil wire, the brazing material has been formed on the surface of the pad portion such that the brazing material has a shape of a mountain having a slope face that is inclined downward from a center of the pad portion toward a periphery of the pad portion and the coil wire is brought into pressure contact with the slope face of the brazing material.

9. The method for manufacturing the antenna device according to claim 8, wherein the coil wire is brought into pressure contact with the slope face toward the center of the pad portion.

10. The method for manufacturing the antenna device according to claim 7, the method further comprises:
cutting the coil wire and the base to remove a part of the coil wire including the one end portion and a part of the base including the wire fixation portion after the pad portion and the coil wire are joined with the brazing material.

11. The method for manufacturing the antenna device according to claim 7,
wherein:
the base includes a support portion that changes a direction in which the coil wire is drawn as the coil wire is pressed against the support portion,
in arranging the coil wire, a bent portion located between the part and the one end portion of the coil wire is pressed against the support portion of the base and thus bends, and
the one end portion of the coil wire bent at the bent portion is tied up to the wire fixation portion of the base.

12. The method for manufacturing the antenna device according to claim 7, wherein in melting the brazing material, an inert gas is supplied to the brazing material along a direction in which the coil wire is pressurized.

13. An antenna device comprising:
an antenna portion formed by winding a coil wire having a coil core and an insulating film covering the coil core; and
a base including a pad portion,
wherein:
the coil wire includes an exposed portion of the coil core that is uncovered with the insulating film and thus is exposed,
the coil wire and the pad portion are joined with a brazing material,
a part of the coil wire is buried in the brazing material, and
a first boundary line and a second boundary line are arranged along each other, the first boundary line being a boundary between, regarding a peripheral face of the coil wire, an interior region buried in the brazing material and an exterior region located outside of the brazing material, the second boundary line being a boundary between the exposed portion and a covered portion of the coil wire that is covered with the insulating film.

14. The antenna device according to claim 13, wherein a thickness of the brazing material is greater than a wire diameter of the coil wire.

15. The antenna device according to claim 13, wherein a part of the coil wire in a radial direction corresponds to the exposed portion, while another part of the coil wire in the radial direction corresponds to the covered portion across a partial length region of the coil wire.

16. The antenna device according to claim 15, wherein a part of an upper side of the coil wire opposite to a side where the pad portion is arranged and a part of a lower side of the coil wire facing the pad portion each correspond to the exposed portion, and thus are in contact with the brazing material across the partial length region of the coil wire, while a part of a lateral side of the coil wire corresponds to the covered portion, and thus is not in contact with the brazing material across the partial length region.

17. The antenna device according to claim 16, wherein a part of an upper side of the lateral side of the partial length region corresponds to the covered portion, and thus is not in contact with the brazing material, while an entire lower side of the lateral side of the partial length region corresponds to the exposed portion, and thus is in contact with the brazing material.

18. The antenna device according to claim 15, wherein a first insulating film and a second insulating film are connected by a bridge portion having a width smaller than a wire diameter of the coil wire and extending along an extension direction of the coil wire, the first insulating film and the second insulating film respectively covering entire portions in the radial direction of a first length region and a second length region sandwiching the partial length region, buried in the brazing material, of the coil wire.

19. The antenna device according to claim 13, wherein opposite end faces of the coil wire and a side end face of the base are arranged flush with each other.

20. The antenna device according to claim 13,
wherein:
opposite ends of the coil wire are respectively joined to a pair of pad portions provided on the base with the brazing material,
each of the pair of pad portions is formed in a rectangular shape,
each rectangular shape has a shape with an oblique side formed by chamfering a corner on an inner side of each of the pair of pad portions, and
the oblique side lies along an extension direction of the coil wire.
